(19) United States
(12) Patent Application Publication
(10) Pub. No.: US 2026/0025529 A1
(43) Pub. Date: Jan. 22, 2026

(54) VIDEO ENCODING AND DECODING

(71) Applicant: TENCENT TECHNOLOGY (SHENZHEN) COMPANY LIMITED, Shenzhen (CN)

(72) Inventor: Han ZHANG, Shenzhen (CN)

(73) Assignee: TENCENT TECHNOLOGY (SHENZHEN) COMPANY LIMITED, Shenzhen (CN)

(21) Appl. No.: 19/340,360

(22) Filed: Sep. 25, 2025

Related U.S. Application Data
(63) Continuation of application No. PCT/CN2024/102165, filed on Jun. 28, 2024.

(30) Foreign Application Priority Data
Jun. 30, 2023 (CN) 202310801736.8

(51) Int. Cl. H04N 19/82; G06V 10/764; H04N 19/117; H04N 19/119; H04N 19/184; H04N 19/86

(52) U.S. Cl. CPC H04N 19/82; G06V 10/764; H04N 19/117; H04N 19/119; H04N 19/184; H04N 19/86

(57) ABSTRACT

In some examples, classification information of image data is obtained, the classification information includes at least one of a target range, intermediate information, or a category subset. A target category is determined according to the classification information, the target category indicates a category of an adaptive loop filter to be used during processing of the image data. The target range includes at least one of a first dynamic range that is determined based on pixel information of the image data and a second dynamic range that is selected from one or more preset ranges, and a preset range has a range width less than a maximum range width for a signal bit width of the image data. The intermediate information is generated during the processing of the image data. The category subset includes at least two subcategories that are respectively determined based on respective classifiers in a classifier group.

### RELATED APPLICATIONS

The present application is a continuation of International Application No. PCT/CN2024/102165, filed on Jun. 28, 2024, which claims priority to Chinese Patent Application No. 202310801736.8, filed on Jun. 30, 2023. The entire disclosures of the prior applications are hereby incorporated by reference.

### FIELD OF THE TECHNOLOGY

This disclosure relates to the fields of video encoding and decoding technologies, multimedia, cloud technologies, artificial intelligence, and the like, including video processing techniques, a video encoding and decoding method and apparatus, an electronic device, and a storage medium.

### BACKGROUND OF THE DISCLOSURE

In video encoding and decoding, various technologies can be configured to compress video data, so that one or more video encoding and decoding standards can be executed to perform encoding and decoding on the video data. For example, the video encoding and decoding standards may include, but is not limited to, Versatile Video Coding (VVC), Joint Exploration Test Model (JEM), High Efficiency Video Coding (H.265/HEVC), Advanced Video Coding (H.264/AVC), Moving Picture Expert Group (MPEG) coding, and the like. Video encoding and decoding can usually perform a prediction method (for example, inter-frame prediction or intra-frame prediction). The prediction method uses redundancy existing in sequences of image frames of a video. For example, as video encoding and decoding is performed, redundancy existing in image frames of a video can be reduced or removed from video data.

### SUMMARY

Embodiments of this disclosure provide a video encoding and decoding method and apparatus, an electronic device, and a storage medium, to improve accuracy of determining a category of an ALF, thereby improving video encoding and decoding efficiency.

Some aspects of the disclosure provide a method of video processing. In some examples, classification information of image data is obtained, the classification information includes at least one of a target range, intermediate information, or a category subset. For the image data, a target category is determined according to the classification information, the target category indicates a category of an adaptive loop filter to be used during processing of the image data. The target range includes at least one of a first dynamic range or a second dynamic range, the first dynamic range is a value range determined based on pixel information of the image data, the second dynamic range is a preset range selected from one or more preset ranges, and at least one of the one or more preset ranges have a range width less than a maximum range width for a signal bit width of the image data. The intermediate information is generated during the processing of the image data. The category subset includes at least two subcategories that are respectively determined based on respective classifiers in a classifier group.

Some aspects of the disclosure provide an apparatus that includes processing circuitry configured to perform the method of video processing.

Some aspects of the disclosure also provide a non-transitory computer-readable storage medium storing instructions which when executed by at least one processor cause the at least one processor to perform the method of video processing.

According to an aspect, the embodiments of this disclosure provide a video encoding and decoding method. The method includes: obtaining information configured for classification that is of image data, the information configured for classification including at least one of a target range, intermediate information, or a category subset; determining for the image data a target category corresponding to the information configured for classification, the target category indicating a category of an adaptive loop filter for encoding and decoding of the image data; the target range including at least one of a first dynamic range or a second dynamic range, the first dynamic range being a value range determined based on pixel information of the image data, the second dynamic range being a preset range determined from one or more preset ranges, and at least one of the preset ranges being less than a maximum range that can be represented by a signal bit width of the image data; the intermediate information including information generated in the encoding and decoding of the image data; and the category subset including at least two subcategories, and the at least two subcategories are categories of the image data that are respectively determined by using each classifier in a classifier group.

According to another aspect, the embodiments of this disclosure provide a video encoding and decoding apparatus. The apparatus includes: an information obtaining module, configured to obtain information configured for classification that is of image data, the information configured for classification including at least one of a target range, intermediate information, or a category subset; and a classification module, configured to determine for the image data a target category corresponding to the information configured for classification, the target category indicating a category of an adaptive loop filter for encoding and decoding of the image data; the target range including at least one of a first dynamic range or a second dynamic range, the first dynamic range being a value range determined based on pixel information of the image data, the second dynamic range being a preset range determined from one or more preset ranges, and at least one of the preset ranges being less than a maximum range that can be represented by a signal bit width of the image data; the intermediate information including information generated in the encoding and decoding of the image data; and the category subset including at least two subcategories, and the at least two subcategories are categories of the image data that are respectively determined by using each classifier in a classifier group.

According to another aspect, the embodiments of this disclosure provide an electronic device, including a memory, a processor (an example of processing circuitry), and a computer program that is stored in the memory, and the processor performing the computer program to implement operations of the method according to any of the above aspects.

According to another aspect, the embodiments of this disclosure provide a computer readable storage medium (e.g., non-transitory computer readable storage medium), storing a computer program, and the computer program, when executed by a processor, implementing operations of the method according to any one of the above aspects.

According to another aspect, the embodiments of this disclosure provide a computer program product, including a computer program, and the computer program, when executed by a processor, implementing operations of the method according to any of the above aspects.

### BRIEF DESCRIPTION OF THE DRAWINGS

FIG. 1 is a schematic diagram of a system architecture for implementing encoding and decoding according to an embodiment of this disclosure.

FIG. 2 is a schematic flowchart of a video encoding and decoding method according to an embodiment of this disclosure.

FIG. 3 is a schematic diagram of image filtering according to an embodiment of this disclosure.

FIG. 4 is a schematic diagram of different categories of rhombic filter according to an embodiment of this disclosure.

FIG. 5 is a schematic diagram of tap coefficients respectively corresponding to various samples of an input filter according to an embodiment of this disclosure.

FIG. 6 is a schematic diagram of comparison between image data and a first image according to an embodiment of this disclosure.

FIG. 7 is a schematic diagram of comparison between image data and a second image according to an embodiment of this disclosure.

FIG. 8 is a schematic diagram of comparison between image data and a third image according to an embodiment of this disclosure.

FIG. 9 is a schematic flowchart of another video encoding and decoding method according to an embodiment of this disclosure.

FIG. 10 is a schematic structural diagram of a video encoding and decoding apparatus according to an embodiment of this disclosure.

FIG. 11 is a schematic structural diagram of an electronic device according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

It is noted that, unless stated, singular forms “a/an”, “one”, and “the” used herein may also include plural forms. In addition, the terms “include” and “comprise” used in the embodiments of this disclosure mean that the corresponding features may be implemented as the presented features, information, data, operations, operations, components, and/or components, but do not exclude implementation as other features, information, data, operations, operations, components, and/or combinations thereof supported in the technical field. When a component is referred to as being “connected” or “coupled” to another component, the component may be directly connected or coupled to the another component, or a connection relationship is established between the component and the another component by using an intermediate component. In addition, the term “connected” or “coupled” used herein may include wireless connection or wireless coupling. The term “and/or” used herein indicates at least one of items limited by the term. For example, “A and/or B” indicates implementation as “A”, implementation as “A”, or implementation as “A and B”. The term “plurality of” means “more than two”.

To make the objectives, technical solutions, and advantages of this disclosure clearer, the following further describes the implementations of this disclosure in detail with reference to the accompanying drawings.

The following describes the technical solutions of the embodiments of this disclosure and technical effects generated by the technical solutions of this disclosure by using descriptions of several examples of implementations. The following implementations may refer to, pertain to, or be combined with each other. Same terms, similar features, similar implementation operations, and the like in different implementations are not described again.

First, several terms described in the embodiments of this disclosure are introduced and explained. Examples of terms involved in the aspects of the disclosure are briefly introduced. The descriptions of the terms are provided as examples only and are not intended to limit the scope of the disclosure.
ALF: Adaptive Loop Filtering
APS: Adaptation Parameter Set
BIF: Bilateral filter
CC-ALF: Cross-Component Adaptive Loop Filtering
CCSAO: Cross-Component Sample Adaptive Offset
CTB: Coding Tree Block
CTU: Coding Tree Unit
DF: Deblocking Filter
ECM: Enhanced Compression Model
PPS: Picture Parameter Set
RDA: Rate-Distortion Optimization
SAO: Sample Adaptive Offset
SPS: Sequence Parameter Set
VTM: VVC test model
VVC: Versatile Video Coding

Second, a system framework in the embodiments of this disclosure is described by using an example.

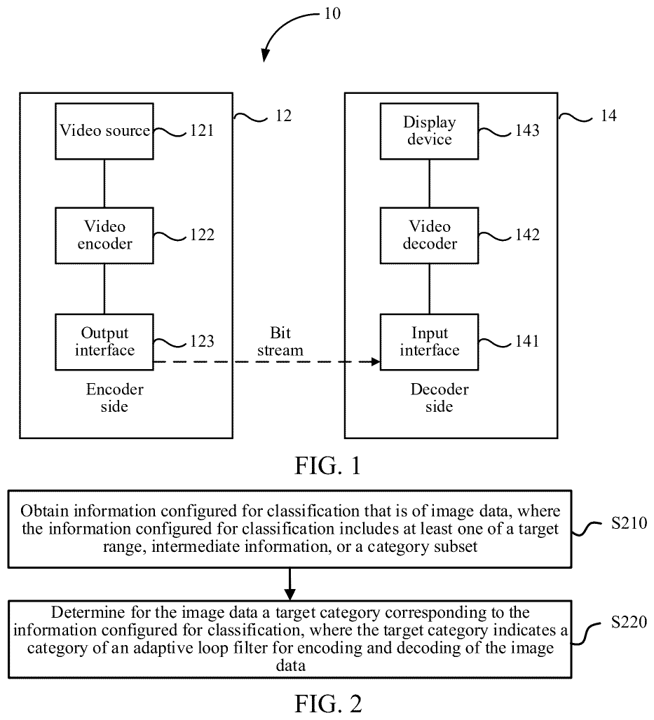

FIG. 1 is a schematic diagram of a system architecture for implementing encoding and decoding according to an embodiment of this disclosure. As shown in FIG. 1, a system 10 includes an encoder side 12. The encoder side 12 may provide encoded video data to a decoder side 14, and the decoder side 14 may decode the encoded video data. The encoder side 12 and the decoder side 14 may include any one of a plurality of devices, including at least one of a desktop computer, a notebook computer, a tablet computer, a set-top box, an intelligent terminal (such as a so-called “intelligent” phone), a television, a camera, a display device, a digital media player, a video game console, or a video streaming device. In some cases, the encoder side 12 and the decoder side 14 are equipped for wireless communication. Therefore, the encoder side 12 and the decoder side 14 may be wireless communications devices. The technologies described in the embodiments of the present disclosure may be applied to a wireless and/or wired application. The encoder side 12 is an example of a video encoding device, that is, a device configured to encode video data. In an example, the decoder side 14 is a video decoding device, that is, a device configured to decode video data.

The system 10 shown in FIG. 1 is merely an example. Technologies for encoding, decoding, and processing video data may be performed by any digital video encoding and/or decoding device. In some examples, the technologies may be performed by a video coder/decoder, and the video coder/decoder is usually referred to as a codec. The encoder side 12 and the decoder side 14 are examples of such encoding and decoding devices. The encoder side 12 generates encoded video data and sends the encoded video data to the decoder side 14. In some examples, the encoder side 12 and the decoder side 14 operate in a substantially symmetrical manner, so that either of the encoder side 12 and the decoder side 14 includes video encoding and decoding components. Therefore, the system 10 may support unidirectional or bidirectional video transmission between the encoder side 12 and the decoder side 14, for example, video streaming, video playback, video broadcasting, or video calling.

In the example in FIG. 1, the encoder side 12 includes a video source 121, a video encoder 122, and an output interface 123. The decoder side 14 includes an input interface 141, a video decoder 142, and a display device 143. In other examples, the encoder side 12 and the decoder side 14 include other components or arrangements. For example, the encoder side 12 may receive video data from an external video source (such as an external camera). Similarly, the decoder side 14 may be connected to an external display device instead of including an integrated display device.

The video source 121 is a video data source. Video data may include a series of pictures. The video source 121 may include a video capture device (such as a camera), a file including a previously captured video, and/or a video feed interface for receiving video data from a video content provider. In some examples, the video source 121 generates computer graphic-based video data, or a combination of a live video, a filed video, and a computer-generated video. In each case, a captured, pre-captured, or computer-generated video may be encoded by the video encoder 122.

In some examples, the video encoder 122 and the video decoder 142 encode and decode video data according to one or more video encoding and decoding standards or specifications. For example, the video encoder 122 and the video decoder 142 may encode and decode video data according to ITU-T H.261, ISO/IEC MPEG-1 Visual, ITU-T H.262, or ISO/IEC MPEG-2 Visual, ITU-T H.263, ISO/IEC MPEG-4 Visual, and ITU-T H.264 (also referred to as ISO/IEC MPEG-4 AVC) (including Scalable Video Coding (SVC) and Multi-view Video Coding (MVC) extensions thereof or another video encoding and decoding standard or specification). In some examples, the video encoder 122 and the video decoder 142 encode and decode video data according to an HEVC standard (referred to as ITU-T H.265, with its range and screen content extended by encoding and decoding, its 3D HEVC (3D-HEVC), its Multi-view HEVC (MV-HEVC), or its Scalable HEVC (SHVC)).

The technical solution in the embodiments of this disclosure may be applied to an advanced video codec (such as an extension of HEVC or a next-generation video encoding and decoding standard, for example, H.266/VVC).

In the field of video encoding and decoding, filtering (for example, ALF) is usually applied to enhance quality of a reconstructed and/or decoded video signal. In the embodiments of this disclosure, a reconstructed video data block may refer to a video data block that has been reconstructed in a reconstruction loop of the video encoder 122, or may refer to a video data block decoded by the video decoder 142. In some examples, a filter may be used as a post-filter, in which a filter frame is not configured to predict a future frame; or the filter may be used as a loop filter, in which a filter frame is configured to predict a future frame. For example, the filter may be designed by minimizing an error between an original signal and a reconstructed/decoded filtered signal.

In a related technology of video encoding and decoding, a video encoding and decoding process usually needs an ALF. The ALF can adaptively determine a filter coefficient based on different video content, to reduce a mean square error (MSE) between a reconstructed component and an original component, thereby improving video quality.

However, in practice, current video quality needs to be further improved.

In a related technology, classification of adaptive loop filtering in video encoding and decoding may determine an ALF category based on a maximum dynamic range that can be represented by a signal bit width of a video image. However, when the ALF category is determined, intermediate information of a video image in an encoding and decoding process is not used, or the ALF category is determined based on a single classifier.

In a solution of determining the ALF category based on the maximum dynamic range that can be represented by the signal bit width of the video image, video image signals are usually distributed in a limited dynamic range, and determining the ALF category based on the maximum dynamic range causes low determining accuracy, thereby causing low video quality. In addition, a plurality of different categories of intermediate information is generated in the encoding and decoding process, and the intermediate information can be used as reference for determining the ALF category to some extent. However, the intermediate information is not used in the related technology. Consequently, accuracy of determining the ALF category is not high, and therefore, video quality is not high. In addition, a corresponding ALF category of a single classifier is limited. Consequently, a determined ALF category is also limited to some extent, which also causes low accuracy of determining the ALF category, and thus low video quality. A classification result of the adaptive loop filtering affects video quality to some extent. Therefore, to further improve video quality, classification accuracy of the adaptive loop filtering may be promoted.

FIG. 2 is a schematic flowchart of a video encoding and decoding method according to an embodiment of this disclosure. The method of this embodiment may be applied to an electronic device. The electronic device may be an encoder side, or may be a decoder side, or may separately serve as an encoder side and a decoder side. This is not limited herein. The method in FIG. 2 includes the following operations:

S210: Obtain information configured for classification corresponding to image data, where the information configured for classification includes at least one of a target range, intermediate information, or a category subset.

The image data may include at least one of an image sequence, a frame of image, and a slice, a tile, or a block in the frame of image. In other words, a level of the image data is one of sequence-level, frame-level, slice-level, tile-level, or block-level. In operation S210, information configured for classification of at least one level can be acquired. In this embodiment, the image sequence includes at least two frames of images. In another embodiment, the image sequence may include at least two consecutive frames of images. In this embodiment, the encoding and decoding method may be performed by using the image data as a unit. In some examples, if the image data in this embodiment is an image sequence, a category of adaptive loop filtering to be used is determined by using the image sequence as a unit. Similarly, if the image data in this embodiment is a frame of image, a category of the adaptive loop filtering to be used is determined by using the frame of image as a unit.

The target range includes at least one of a first dynamic range or a second dynamic range. The first dynamic range is a range determined based on pixel information of the image data. The second dynamic range is a preset range determined from one or more preset ranges, and at least one of the preset ranges is less than a maximum range that can be represented by a signal bit width of the image data.

In this embodiment, a range determined based on the pixel information of the image data may be less than or equal to the maximum range that can be represented by the signal bit width of the image data, and is determined based on an actual calculation result. This is not limited herein. The target range may be understood as a subset of the maximum range. In some examples, the maximum range may be 0 to 2\hat{ }(signal bit width−1). For example, in an example in which the signal bit width is lobit, the maximum range may be 0 to 1,023. For another example, in an example in which the signal bit width is 8 bit, the maximum range may be 0 to 511. In some examples, the second dynamic range may be a part or all of a total range that can be formed by all the preset ranges.

For the information configured for classification including the target range, the target range includes at least one of the first dynamic range or the second dynamic range, where the first dynamic range is a range determined based on the pixel information of the image data, the second dynamic range is a range determined from one or more preset ranges, and at least one of the preset ranges is less than the maximum range that can be represented by the signal bit width of the image data. In other words, the target range of the category of the adaptive loop filter configured for determining the image data may be less than the maximum range. Therefore, the target range better matches the image data than the maximum range does (that is, the target range can more accurately represent the value range of the pixel information of the image data than a fixed maximum range), so that accuracy of determining the ALF category is improved, and video quality is further improved.

The intermediate information includes information generated in an encoding and decoding process of the image data.

In this embodiment, some intermediate information may be generated in the encoding and decoding process of the image data. The intermediate information is valuable to some extent for determining a target category. Therefore, the target category of the adaptive loop filter corresponding to the image data may be determined by using the intermediate information.

In some examples, the intermediate information may be information that is not used in a solution for determining an adaptive loop filter in the related technology.

With iteration of technologies, information configured for determining the adaptive loop filter varies accordingly. Specific intermediate information is not limited in this embodiment.

For the information configured for classification including the intermediate information, the intermediate information includes information generated in the encoding and decoding process of the image data. In the embodiments of this disclosure, more valuable intermediate information may be configured to determine the category of the adaptive loop filter to be used, so that accuracy of determining the ALF category is improved, and video encoding and decoding efficiency is further improved.

The category subset includes at least two subcategories, and the at least two subcategories are categories (that is, categories of the adaptive loop filter corresponding to the image data) of the image data and are respectively determined by using classifiers in a classifier group. Each subcategory respectively corresponds to a classifier.

In this embodiment, the classifier group includes at least two different classifiers, and each classifier in the classifier group can determine a subcategory corresponding to the image data from a plurality of corresponding categories. Therefore, when the image data is classified by using the classifier group, a category corresponding to each classifier in the classifier group can be obtained, and further a target category can be determined based on the category corresponding to each classifier.

By combining the information configured for classification with category results respectively output by the at least two classifiers in the classifier group, the category of the adaptive loop filter corresponding to the image data is determined. In this way, accuracy of determining the category of the ALF is also improved, and video encoding and decoding efficiency is further improved.

S220: Determine, for the image data, a target category corresponding to the information configured for classification, where the target category indicates a category of an adaptive loop filter for encoding and decoding of the image data.

In this embodiment, the information configured for classification includes at least one of a target range, intermediate information, or a category subset. In other words, in this embodiment, the target category of the adaptive loop filter corresponding to the image data may be determined based on at least one of the target range, the intermediate information, or the category subset.

In the technical solution of this embodiment, information for classification corresponding to image data is obtained, and a target category of an adaptive loop filter corresponding to the image data is determined based on the information configured for classification. The information configured for classification includes at least one of a target range, intermediate information, or a category subset. The target range includes at least one of a first dynamic range or a second dynamic range, where the first dynamic range is a range determined based on pixel information of the image data, the second dynamic range is a range determined based on one or more preset ranges, and at least one of the preset ranges is less than a maximum range that can be represented by a signal bit width of the image data. The intermediate information includes information generated in an encoding and decoding process of the image data (that is, information related to the image data and generated in the encoding and decoding process). The category subset includes at least two subcategories, and the at least two subcategories are categories of the image data and are respectively determined by using the classifiers in the classifier group, and each subcategory respectively corresponds to a classifier. In this way, accuracy of determining the ALF category is improved, and video encoding and decoding efficiency is further improved.

Based on any one of the foregoing embodiments and by using VCC as an example, the following embodiment further describes how to perform classification and filtering in video encoding and decoding.

The ALF and CCALF, as loop filters used in the VVC, are Wiener filters, and may adaptively determine a filter coefficient based on different video content, thereby reducing an MSE between a reconstructed component (for example, a reconstructed luma component or a reconstructed chroma component) and an original component. An input of the ALF is, for example, a reconstructed pixel value before being processed by the ALF; and an output of the ALF is an augmented reconstructed pixel value, for example, a reconstructed luma pixel value or a reconstructed chroma pixel value. As an adaptive filter, a Wiener filter can generate different filter coefficients for video content with different characteristics. Therefore, the ALF needs to first classify video content, and use a corresponding filter for video content of each category. In a design of VVC, each 4×4 block is classified into one of 25 categories based on directionality and activity of the block. A corresponding filter coefficient is calculated for each category of the video content.

For the luma component, in addition to 4×4 block-level adaptation, the VVC further supports an ALF adaptive switch of a CTU level. Each CTU may use a filter bank generated for a current slice, or may use a filter bank generated by using an encoded slice, or a group of fixed filters in 16 fixed filter banks trained offline. In a CTU, each 4×4 block selects, based on a category to which the block belongs, a filter of a corresponding category from the filter bank for filtering. The filter coefficient and a corresponding clipping index are transmitted to the decoder side by an ALF_APS. One ALF_APS may include one luma filter bank (including a maximum of 25 filters) and a maximum of eight chroma filters.

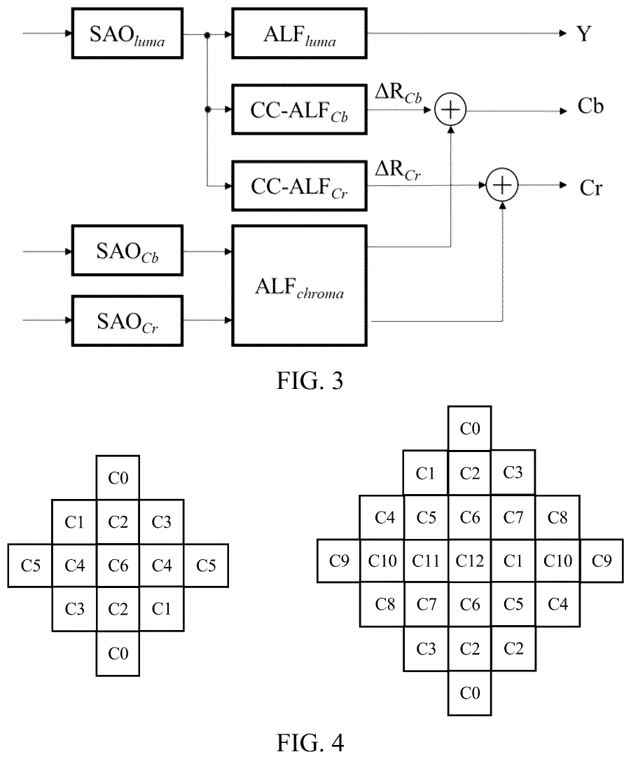

CCALF uses a luma component to correct a chroma component. Processing procedures of the ALF and the CCALF are shown in FIG. 3. The CCALF uses the luma component as an input, and outputs a corrected value of the chroma component. Whether a corresponding corrected value is used may be separately controlled by two chroma components. The corrected value and an output of the chroma ALF jointly form a final chroma component.

In the VVC, different categories of rhombic filters shown in FIG. 4 are used for the ALF. A 7×7 rhombic filter is used for the luma component, that is, a 7×7 rhombic convolution kernel is used, and a 5×5 rhombic filter is used for the chroma component.

For the luma component, the ALF adaptively uses different filters at a sub-block level (4×4), that is, each 4×4 pixel block needs to be classified into one of the 25 categories. For the chroma component, the ALF does not need to classify pixels at a sub-block level, and all chroma pixels in the CTU use a same filter. A category index C of the luma component pixel block is obtained by combining a directionality feature D and a quantized activity feature A of the block. The formula is as follows:

$$C = 5 D + \hat{A} \qquad \# ( 2 - 1 )$$

To calculate D and Ǎ, first, horizontal, vertical, diagonal, and anti-diagonal gradient values of each pixel in the 4×4 pixel block need to be calculated:

$${H}_{k , l} = \vert 2 R ( k , l ) - R ( k - 1 , l ) - R ( k + 1 , l ) \vert \qquad \# ( 2 - 2 )$$

$${V}_{k , l} = \vert 2 R ( k , l ) - R ( k , l - 1 ) - R ( k , l + 1 ) \vert \qquad \# ( 2 - 3 )$$

$$D {0}_{k , l} = \vert 2 R ( k , l ) - R ( k - 1 , l - 1 ) - R ( k + 1 , 1 + 1 ) \vert \qquad \# ( 2 - 4 )$$

$$D {1}_{k , l} = \vert 2 R ( k , l ) - R ( k - 1 , l + 1 ) - R ( k + 1 , l - 1 ) \vert \qquad \# ( 2 - 5 )$$

In the formula, H_{k,l} represents a gradient value in a horizontal direction of a pixel whose position is (k, l) in the 4×4 pixel block, V_{k,l} represents a gradient value in a vertical direction of the pixel whose position is (k, l) in the 4×4 pixel block, D0_{k,l} represents a gradient value in a diagonal direction of the pixel whose position is (k, l) in the 4×4 pixel block, and D1_{k,l} represents a gradient value in an anti-diagonal direction of the pixel whose position is (k, l) in the 4×4 pixel block.

Based on a pixel gradient, overall horizontal, vertical, diagonal, and anti-diagonal gradients of each 4×4 block are calculated as follows:

$${g}_{h} = {\sum }_{k = i - 2}^{i + 5} {\sum }_{l = j - 2}^{j + 5} {H}_{k , l} , {g}_{v} = {\sum }_{k = i - 2}^{i + 5} {\sum }_{l = j - 2}^{j + 5} {V}_{k , l} \qquad \# ( 2 - 6 )$$

$${g}_{d 0} = {\sum }_{k = i - 2}^{i + 5} {\sum }_{l = j - 2}^{j + 5} D {0}_{k , l} , {g}_{d 1} = {\sum }_{k = i - 2}^{i + 5} {\sum }_{l = j - 2}^{j + 5} D {1}_{k , l} \qquad \# ( 2 - 7 )$$

In the formula, i and j represent coordinates of a pixel on an upper left corner of the 4×4 pixel block, and R (k, l) represents a reconstructed pixel value of a position (k, l) before being filtered by the ALF.

After gradient values of the pixel blocks are obtained, a maximum value and a minimum value in the horizontal gradient value and the vertical gradient value respectively are:

$${g}_{h , v}^{max} = max ( {g}_{h} , {g}_{v} ) , {g}_{h , v}^{min} = min ( {g}_{h} , {g}_{v} ) \qquad \# ( 2 - 8 )$$

A maximum value and a minimum value in the diagonal gradient value and the anti-diagonal gradient value respectively are:

$${g}_{d 0 , d 1}^{max} = max ( {g}_{d 0} , {g}_{d 1} ) , {g}_{d 0 , d 1}^{min} = min ( {g}_{d 0} , {g}_{d 1} ) \qquad \# ( 2 - 9 )$$

By comparing the maximum values and the minimum values of the gradient values in the four directions in formulas (2-8) and (2-9), the directionality feature D is derived:

Step 1: If

$${g}_{h , v}^{max} \leq {t}_{1} \cdot {g}_{h , v}^{min} and {g}_{d 0 , d 1}^{max} \leq {t}_{1} \cdot {g}_{d 0 , d 1}^{min}$$

are simultaneously true, D is set to 0.

Step 2: If

$${g}_{h , v}^{max} / {g}_{h , v}^{min} > {g}_{d 0 , d 1}^{max} / {g}_{d 0 , d 1}^{min} ,$$

perform step 3; otherwise, perform step 4.

Step 3: If

$${g}_{h , v}^{max} > {t}_{2} \cdot {g}_{h , v}^{min} ,$$

D is set to 2; otherwise, D is set to 1.

Step 4: If

$${g}_{d 0 , d 1}^{max} > {t}_{2} \cdot {g}_{d 0 , d 1}^{min} ,$$

D is set to 4; otherwise, D is set to 3.

The activity feature A is calculated by using the following formula:

$$A = {\sum }_{k = i - 2}^{i + 5} {\sum }_{l = j - 2}^{j + 5} ( {V}_{k , l} + {H}_{k , l} ) \qquad \# ( 2 - 10 )$$

The activity feature A is quantized to an interval of [0 to 4] and is used as a quantized activity feature Ǎ.

Before each 4×4 luma block is filtered, geometric transformations, including no transformation, diagonal transformation, vertical flip, and rotation transformation, are performed on a filter coefficient and a corresponding clipping value based on a gradient value of a current block and according to rules of Table 1-1. Performing the geometric transformation to the filter coefficient is equivalent to performing the geometric transformation to the pixel values when the coefficient is not changed, and then performing filtering. An objective of the geometric transformation is to align directionality of different block content as much as possible, thereby reducing a category number required by the ALF, and enabling different pixels to share a same filter coefficient. Performing the geometric transformation can improve a true category number from 25 to 100 without increasing a number of ALF filters, thereby improving self-adaptability of the ALF filters.

TABLE 1-1
Geometric transformation based on pixel block gradient values

| Gradient value | Transformation category |
|---|---|
| g_{d1} < g_{d0} and gₕ < gᵥ | No transformation |
| g_{d1} < g_{d0} and gᵥ ≤ gₕ | Diagonal transformation |
| g_{d0} ≤ g_{d1} and gₕ < gᵥ | Vertical flip |
| g_{d0} ≤ g_{d1} and gᵥ ≤ gₕ | Rotation transformation |

For an ALF filtering process of the VCC, on a decoder side, if an ALF flag bit of a CTU level is true, each pixel R(i, j) in a current CTU is filtered, and a filtering process and an output thereof are as follows:

$${R}^{′} ( i , j ) = R ( i , j ) + ( ( {\sum }_{k \neq 0} {\sum }_{l \neq 0} f ( k , l ) \times K ( R ( i + k , j + l ) - R ( i , j ) , c ( k , l ) ) + 64 ) ≫ 7 ) \qquad \# ( 2 - 11 )$$

In the formula, f(k,l) represents a filter tap coefficient, K(x, y) is a clipping function, and c(k,l) is a parameter related to a clipping operation. The value range of k and 1 is

$$- \frac{L}{2} to \frac{L}{2} ,$$

where L is a length of a filter. A specific definition of the clipping function is K(x, y)=min(y, max(−y, x)). The clipping operation adds a nonlinear function to the ALF, and can reduce an impact of a pixel with an excessively large peripheral difference on a current pixel.

In ECM-8.0, a downsampling operation when a gradient is calculated in an ALF classification process and a limitation of a virtual boundary are removed. Meanwhile, a basic unit of an ALF classification operation changes from a 4×4 sub-block to a 2×2 sub-block. In addition, shapes of a luma filter and a chroma filter also change correspondingly.

For the luma component, three different classifiers (C0, C1, and C2) and three different groups of filters (F0, F1, and F2) are used in the ECM-8.0. The filter banks F0 and F1 include fixed filters, and coefficients of the fixed filters are generated through offline training based on the classifiers C0 and C1. F2 includes a filter coefficient generated from content to be encoded, and the filter coefficient needs to be written into a bit stream and transmitted to the decoder side.

In the ECM-8.0, each 2×2 sub-block generates a corresponding category index Cᵢ based on a directionality feature Dᵢ and an activity feature Aᵢ of the sub-block. The category index is shown in the following formula:

$${C}_{i} = {\hat{A}}_{i} * {M}_{D , i} + {D}_{i} \qquad \# ( 2 - 12 )$$

In the formula, i represents a classifier index, and M_{D,i} represents a total quantity of activity features Dᵢ used by a corresponding classifier.

Similar to a calculation process in the VVC, horizontal, vertical, diagonal, and anti-diagonal gradients of each pixel are generated by using a 1-D Laplacian. For the classifier C₀, its sub-block gradient is generated by adding pixel gradient values of all positions in a 4×4 area covering a target 2×2 sub-block. For the classifiers C₁ and C₂, their sub-block gradients are generated by adding pixel gradient values of all positions in a 12×12 area covering a target 2×2 sub-block. If horizontal, vertical, diagonal, and anti-diagonal sub-block gradients are specified as gₕⁱ, gᵥⁱ, g_{d1}ⁱ, g_{d2}ⁱ, the directionality feature Dᵢ can be obtained by comparing the following two values with a group of thresholds:

$${r}_{h , v}^{i} = \frac{max ( {g}_{h}^{i} , {g}_{v}^{i} )}{min ( {g}_{h}^{i} , {g}_{v}^{i} )} , {r}_{d 1 , d 2}^{i} = \frac{max ( {g}_{d 1}^{i} , {g}_{d 2}^{i} )}{min ( {g}_{d 1}^{i} , {g}_{d 2}^{i} )}$$

The directionality feature D₂ uses same thresholds 2 and 4.5 as the VVC does. For D₀ and D₁, horizontal or vertical edge strength E_{HV}ⁱ and diagonal edge strength E_{D}ⁱ are first calculated. A threshold Th=[1.25,1.5,2,3,4.5,8] is used. When

$${r}_{h , v}^{i} \leq Th [ 0 ] ,$$

the edge strength

$${E}_{H V}^{i}$$

### is set to 0. Otherwise,

$${E}_{H V}^{i}$$

is the largest integer satisfying

$${r}_{h , v}^{i} > T h [ {E}_{H V}^{i} - 1 ] .$$

$$When {r}_{d 1 , d 2}^{i} \leq T h [ 0 ] ,$$

the edge strength

$${E}_{D}^{i}$$

### is set to 0. Otherwise,

$${E}_{D}^{i}$$

is the largest integer satisfying

$${r}_{d 1 , d 2}^{i} > Th [ {E}_{D}^{i} - 1 ] . When {r}_{h , v}^{i} > {r}_{d 1 , d 2}^{i} ,$$

that is, the edge strength in a horizontal or vertical direction is stronger, the directionality feature Dᵢ is generated based on Table 1-2 (a). Otherwise, the directionality feature Dᵢ is generated based on Table 1-2 (b).

TABLE 1-2
$Mapping relationship between edge strength {E}_{D}^{i} / {E}_{H V}^{i} and {D}_{i}$

| (a) | | | | | | | | (b) | | | | | | | |
|---|---|---|---|---|---|---|---|---|---|---|---|---|---|---|---|
| | ${E}_{D}^{i}$ | | | | | | | | ${E}_{HV}^{i}$ | | | | | | |
| ${E}_{HV}^{i}$ | 0 | 1 | 2 | 3 | 4 | 5 | 6 | ${E}_{D}^{i}$ | 0 | 1 | 2 | 3 | 4 | 5 | 6 |
| 0 | 0 | 0 | 0 | 0 | 0 | 0 | 0 | 0 | 28 | 0 | 0 | 0 | 0 | 0 | 0 |
| 1 | 1 | 2 | 0 | 0 | 0 | 0 | 0 | 1 | 29 | 30 | 0 | 0 | 0 | 0 | 0 |
| 2 | 3 | 4 | 5 | 0 | 0 | 0 | 0 | 2 | 31 | 32 | 33 | 0 | 0 | 0 | 0 |
| 3 | 6 | 7 | 8 | 9 | 0 | 0 | 0 | 3 | 34 | 35 | 36 | 37 | 0 | 0 | 0 |
| 4 | 10 | 11 | 12 | 13 | 14 | 0 | 0 | 4 | 38 | 39 | 40 | 41 | 42 | 0 | 0 |
| 5 | 15 | 16 | 17 | 18 | 19 | 20 | 0 | 5 | 43 | 44 | 45 | 46 | 47 | 48 | 0 |
| 6 | 21 | 22 | 23 | 24 | 25 | 26 | 27 | 6 | 49 | 50 | 51 | 52 | 53 | 54 | 55 |

The activity feature Ǎᵢ is generated by quantizing sub-block-level gradient accumulation results Aᵢ in horizontal and vertical directions, and a quantized value range is 0 to n. For Ǎ₂, n is set to 4. For Ǎ₀ and Ǎ₁, n is set to 15. One ALF_APS may transmit a maximum of four groups of luma component filters, each group containing a maximum of 25 filters.

In the ECM-8.0, a new classifier is used in a classification process of the ALF. For one of filter banks transmitted to the decoder side, a flag bit is configured to indicate whether an original classifier or a new classifier is used. The new classifier cannot use geometric transformation. When the new classifier is used, pixels at all positions in a 2×2 sub-block are added, and then classification is performed based on a sum of pixel values.

$${class}_{index} = ( sum \times 25 ) ≫ ( sample bitdepth + 2 ) \# \qquad ( 2 - 13 )$$

During ALF filtering, first, two fixed filters F₀ and F₁ that use a 13×13 rhombic filter may generate two intermediate values R₀(x, y) and R₁(x, y) for a current pixel to be filtered. Then, an online-generated filter F₂ is used for R₀(x, y), R₁(x, y) and surrounding pixels to generate filtered pixels, as shown in the following formula:

$$\tilde{R} ( x , y ) = R ( x , y ) + [ {\sum }_{i = 0}^{19} {c}_{i} ( {f}_{i , 0} + {f}_{i , 1} ) ] + [ {\sum }_{i = 20}^{21} {c}_{i} {g}_{i} ] \# \qquad ( 2 - 14 )$$

In the formula, f_{i,j} represents a difference between the surrounding pixels after a clipping operation and the current pixel R(x, y), and gᵢ represents a difference between Rᵢ₋₂₀(x, y) after the clipping operation and the current pixel. A filter coefficient cᵢ, i=0, . . . 21, needs to be transmitted to the decoder side.

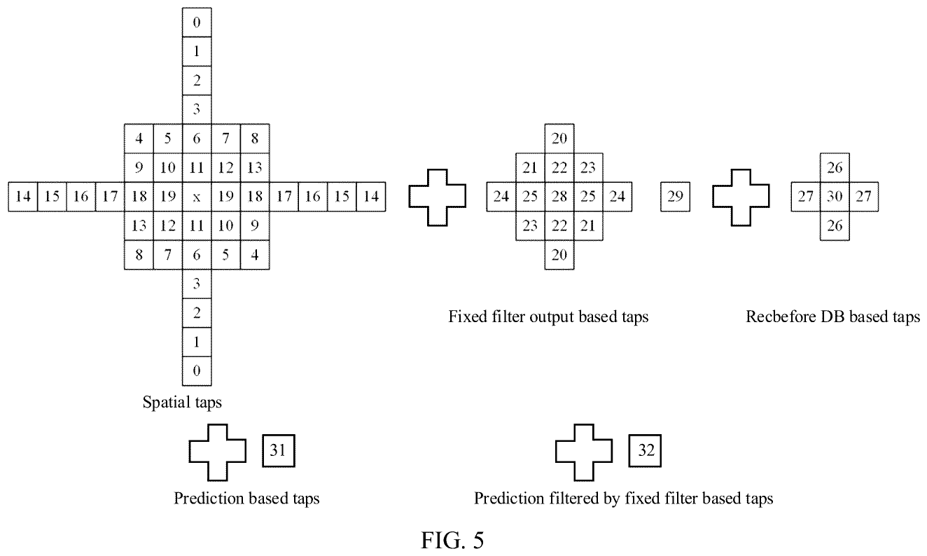

In the ECM-8.0, a luma filter generated through online training includes four categories of inputs in total: a spatial-domain neighboring sample, a reconstructed sample before deblocking, an extended sample generated after being filtered by a fixed filter, and a residual component. As shown in FIG. 5, tap coefficients that respectively correspond to various categories of samples include: spatial taps, fixed filter output based taps, recbefore DB based taps, prediction based taps, and prediction filtered by fixed filter based taps. #0 to #19 represent spatial-domain neighboring samples, #20 to #25, and #28 to #29 represent samples generated after being filtered by the fixed filter, #26, #27, and #30 represent reconstructed samples before deblocking, and #31 and #32 represent residual components. Based on a plurality of input categories, a filtering process is as follows:

$$\tilde{R} ( x , y ) = R ( x , y ) + [ {\sum }_{i = 0}^{19} {c}_{i} ( {f}_{i , 0} + {f}_{i , 1} ) ] + [ {\sum }_{i = 20}^{25} {c}_{i} ( {g}_{i , 0} + {g}_{i , 1} ) ] + [ {\sum }_{i = 26}^{27} {c}_{i} ( {h}_{i , 0} + {h}_{i , 1} ) ] + [ {\sum }_{i = 28}^{29} {c}_{i} {g}_{i} ] + [ {\sum }_{i = 30}^{30} {c}_{i} {h}_{i} ] + [ {\sum }_{i = 31}^{31} {c}_{i} {r}_{i} ] + [ {\sum }_{i = 32}^{32} {c}_{i} {rFiltered}_{i} ] \qquad ( 2 - 15 )$$

In the formula, f_{i,j} represents a difference between a clipped pixel sample surrounding a spatial domain and a current sample R(x, y), gᵢ represents a difference between a clipped pixel sample generated after being filtered by the fixed filter and the current sample R(x, y), and h_{i,j} represents a difference between a clipped reconstructed sample before the deblocking and the current sampleR(x, y). rᵢ represents a clipped residual component, and rFilteredᵢ represents a clipped residual component generated after being filtered by the fixed filter. The residual component and the reconstructed component use a same fixed filter.

In the ALF_APS, a flag bit is configured to indicate whether only the residual component is used or both the residual component and a residual component filtered by fixed filter are used. In JVET-AD0219, a classifier based on a luma residual component is newly proposed as a third classifier of the ALF. For any 2×2 luma sub-block, a sum sum of absolute values of residual components of all positions in an 8×8 area covering the current 2×2 sub-block is first calculated, and then classification is performed based on the accumulated sum by using the following formula:

$$classIDx = sum ≫ ( sample bit depth - 4 ) \# \qquad ( 2 - 16 )$$

A value range of a final category classIdx is 0 to 24. A classifier needs to be transmitted for each filter bank in the ALF_APS.

In a possible implementation, the intermediate information includes at least one of the following:
a reconstructed signal before being filtered by a deblocking filter, where the reconstructed signal includes a reconstructed signal after being filtered by a fixed filter or a reconstructed signal not being filtered by a fixed filter; and
a to-be-processed signal after being filtered by a fixed filter, where the to-be-processed signal includes a luminance signal.

For the deblocking filter and the fixed filter, refer to descriptions in the foregoing embodiments, and details are not described herein again.

In an embodiment, the reconstructed signal before being filtered by the deblocking filter may include a reconstructed signal not being filtered by the fixed filter and before being filtered by the blocking filter, and may further include a reconstructed component after being filtered by the fixed filter and before being filtered by the deblocking filter.

The following embodiments further describe, based on any one of the foregoing embodiments, how to determine a first dynamic range based on pixel information of image data.

In a possible implementation, the determining a first dynamic range based on pixel information of image data includes:
determining a minimum signal value and a maximum signal value corresponding to an image based on the pixel information of the image data; and
determining a range minimum value of the first dynamic range based on the minimum signal value, and determining a range maximum value of the first dynamic range based on the maximum signal value.

In this embodiment, the pixel information may refer to pixel information of each pixel in the image data. The image data includes at least one of an original uncompressed signal, a reconstructed signal, a residual signal, or a predicted signal. In other words, the pixel information may include at least one of an original uncompressed signal, a reconstructed signal, a residual signal, or a predicted signal.

The original uncompressed signal refers to a signal in which image data is not compressed and encoded. The reconstructed signal may be obtained by reconstructing a signal that is obtained by encoding and decoding an original uncompressed signal. The residual signal may be a signal obtained by processing an original uncompressed signal through a residual encoding and decoding technology. The predicted signal may be a signal obtained by processing an original uncompressed signal through a predictive encoding and decoding technology.

In this embodiment, the minimum signal value and the maximum signal value are determined based on at least one of the original uncompressed signal, the reconstructed signal, the residual signal, or the predicted signal.

In some examples, using an example in which the image data includes one of the foregoing signals, a minimum signal value and a maximum signal value in the image data may be determined for a signal value corresponding to each pixel in the image data. Using an example in which the image data includes at least two of the foregoing signals, the at least two of the foregoing signals may be normalized, and then a signal value corresponding to each pixel is calculated, to further determine the first dynamic range.

In an embodiment, the range minimum value is not less than the minimum signal value, and the range maximum value is not greater than the maximum signal value.

In this embodiment, for example, if the image data corresponds to an image sequence, a signal value corresponding to each pixel in the image sequence is determined, and then a minimum signal value and a maximum signal value in the image sequence are determined, to determine a target range corresponding to the image sequence. Similarly, if the image data corresponds to a frame of image, a minimum signal value and a maximum signal value in the frame of image is determined. Similarly, for a slice, a tile, or a block, refer to the descriptions of the image sequence and the frame of image, and details are not described herein again.

In the technical solution of this embodiment, a minimum signal value and a maximum signal value that correspond to an image are determined based on pixel information of image data, a range minimum value of a first dynamic range is determined based on the minimum signal value, and a range maximum value of the first dynamic range is determined based on the maximum signal value. Therefore, classification can be performed with reference to actual image content, thereby improving accuracy of a determined filter category.

The following embodiments describe, based on any one of the foregoing embodiments, a second dynamic range.

In a possible implementation, a quantity of preset ranges is N, and N is an integer not less than 1. In other words, the quantity of preset ranges may be one or more than two, and may be set as required. This is not limited herein. In some examples, when N≥2, any two preset ranges of the N preset ranges may have different values. In some embodiments, when N≥2, M preset ranges may be a maximum range, N-M preset ranges are all less than the maximum range, and M is a natural number less than 2. In some embodiments, when N≥3, any two preset ranges of the N-M preset ranges do not have a same value.

If N is 1, that is, if the quantity of preset ranges is 1, the preset range is less than the maximum range. If N≥2, that is, at least one preset range of more than N preset ranges is less than the maximum range. In other words, partial or all preset ranges of the more than N preset ranges are less than the maximum range.

In a possible implementation, if the quantity of preset ranges is one, the preset range may be used as a second preset range.

In this embodiment, a preset range is preset, then a target category may be directly determined based on the preset range. In this case, efficiency of determining the target category is improved, and coding efficiency is further improved.

In another possible implementation, if N≥2, that is, the quantity of preset ranges is more than 2, the second dynamic range may be selected from the N preset ranges. In the N preset ranges, M preset ranges are the maximum ranges, N-M preset ranges are less than the maximum ranges, where M is a natural number less than 2.

For example, the N preset ranges are as follows:

[l₀, h₀], [l₁, h₁], . . . , [lₙ₋₁, . . . , hₙ₋₁]. Intervals are different from each other, and at most one dynamic range is a maximum dynamic range that can be represented by a signal bit width, and remaining dynamic ranges are sub-ranges of the maximum dynamic range that can be represented by the signal bit width. In this case, one of the N preset ranges may be selected as the second dynamic range, that is, one is selected from the following N preset ranges:

$$[ {l}_{0} , {h}_{0} ] , [ {l}_{1} , {h}_{1} ] , … , [ {l}_{n - 1} , {h}_{n - 1} ] .$$

In this embodiment, at least two preset ranges are preset, then different preset ranges may be selected based on different situations. In this case, flexibility and accuracy of selected preset ranges are improved, accuracy of determining a target category is also improved, and video encoding and decoding efficiency is further improved.

The following embodiments describe, based on any one of the foregoing embodiments, a situation of at least one of the first dynamic range or the second dynamic range.

In a possible implementation, when the target range includes the first dynamic range and the second dynamic range, the target range may be a union set of the first dynamic range and the second dynamic range, or may be an intersection set of the first dynamic range and the second dynamic range. The target range may be selected based on an actual requirement, and is not limited herein.

The first dynamic range is determined with reference to the pixel information, and the second dynamic range is determined based on the preset ranges. In this case, more dimensions are considered for the determined target range, and the target range is more accurate, thereby further improving ALF classification accuracy.

The following embodiments further respectively describe, based on any one of the foregoing embodiments, how to determine the target category based on the target range, how to determine the target category based on the intermediate information, how to determine the target category based on the category subset, and how to determine the target category based on the target range, the intermediate information, and the category subset.

First, how to determine the target category based on the target range is further described.

In a possible implementation, the target category may be determined with reference to the following formula 2-17.

$$classIdx = \frac{( input - {range}_{min} ) * total\_number}{{range}_{max} - {range}_{min} + 1} \qquad ( 2 - 17 )$$

In the formula, input represents information configured for classification, rangeₘᵢₙ, rangeₘₐₓ respectively represent a range minimum value and a range maximum value of a real dynamic range, and total_number represents a quantity of all categories of a corresponding classifier.

In an embodiment, input information may be determined based on a signal value of each pixel in the image data, for example, a sum of signal values of pixels in the image data.

Second, how to determine the target category based on the intermediate information is further described.

In a possible implementation, the target category may be determined with reference to the foregoing formula 2-17.

In this embodiment, the input information configured for classification includes intermediate information. rangeₘᵢₙ, rangeₘₐₓ may respectively represent a range minimum value and a range maximum value of a real dynamic range, or may represent a range minimum value and a range maximum value of a maximum range, which are not limited herein.

Third, how to determine the target category based on the category subset is further described.

In a possible implementation, a subcategory corresponding to each classifier in the classifier group is determined with reference to the foregoing formula 2-17, and then the target category is determined from L preset categories based on at least two subcategories.

L is a product of quantities of categories respectively corresponding to classifiers in the classifier group. In this embodiment, after at least two classifiers are combined, a quantity of categories corresponding to the classifier group increases exponentially. Compared with a single classifier, in this embodiment, a target classification can be selected from L more detailed preset categories, thereby improving accuracy of the determined target classification and improving video quality.

For example, assuming that currently there are a first classifier and a second classifier, a quantity of categories corresponding to the first classifier is a, and a quantity corresponding to the second classifier is b, then in the related technology, an ALF classification may be determined by using the first classifier or the second classifier, that is, the determined ALF classification is one of a and b. However, in this embodiment, the target classification may be selected from a*b=L preset classifications by using the classifier group.

In some examples, each classification in the L preset classifications in this embodiment is related to one category corresponding to each classifier in the classifier group. A quantity, obtained through permutations and combinations, of preset categories corresponding to the classifier group, is a product of the quantities of categories respectively corresponding to the classifiers in the classifier group.

In an embodiment, a target filter coefficient corresponding to each preset classification in the L preset classifications may be related to a filter coefficient corresponding to one category of each classifier. For example, a target filter coefficient corresponding to a fifth preset classification in the L preset classifications is separately related to a filter coefficient corresponding to a first preset classification in the first classifier and a filter coefficient corresponding to a second preset classification in the second classifier. For example, the fifth preset classification may be an average value of the filter coefficient corresponding to the first preset category and the filter coefficient corresponding to the second preset category in the second classifier. This is not limited herein.

In a possible implementation, a subcategory is represented through a category index, and a subcategory is a category in a category range corresponding to a classifier.

The determining, based on the information configured for classification, a target category of an adaptive loop filter corresponding to the image data includes:

based on the category index of each subcategory in a category subset, determining a category index classIdx of the target category by using the following expression:

$$classIdx = ( {n}_{1} * {n}_{2} * … * {n}_{k - 1} ) * {classIdx}_{0} + ( {n}_{2} * … * {n}_{k - 1} ) * {classIdx}_{1} + … + {classIdx}_{k - 1} \qquad ( 2 - 18 )$$

In the expression, k represents a quantity of classifiers included in the classifier group, nₖ₋₁ represents a quantity of categories corresponding to a k^{th} classifier, and classIdxₖ₋₁ represents an index of a subcategory corresponding to the k^{th} classifier in the category subset.

In this embodiment, category indexes in the L preset classifications may be defined in the following method:

One of k classifiers may be first selected as a current classifier, and a category index corresponding to each classifier of the remaining k-1 classifiers remains the same. In this case, the category indexes in the L preset classifications are defined based on a change of a category index corresponding to the current classifier. Next, the current classifier is replaced, and the category indexes in the L preset classifications continue to be defined until any classifier in the k classifiers is polled as the current classifier.

Using an example in which the k classifiers include the first classifier and the second classifier, assuming that the first classifier corresponds to three categories, and the second classifier corresponds to two categories, then a classifier group corresponds to six categories. In this case, category indexes of the six categories may be defined as follows:

A first subcategory index of the first classifier and a first subcategory index of the second classifier are defined as a first category index of the classifier group, the first subcategory index of the first classifier and a second subcategory index of the second classifier are defined as a second category index of the classifier group, a second subcategory index of the first classifier and the first subcategory index of the second classifier are defined as a third category index of the classifier group, the second subcategory index of the first classifier and the second subcategory index of the second classifier are defined as a fourth category index of the classifier group, the third category index of the first classifier and the first subcategory index of the second classifier are defined as a fifth category index of the classifier group, and the third category index of the first classifier and the second subcategory index of the second classifier are defined as the sixth class index of the classifier group.

In this case, a final category index of a combined classifier may be:

$$classIdx = 25 * {classIdx}_{0} + {classIdx}_{1}$$

In the formula, x₀ and x₁ respectively represent a subcategory index corresponding to the first classifier and a subcategory index corresponding to the second classifier.

In the technical solution of this embodiment, the category index of the target category in the L preset classifications can be quickly determined based on the category index corresponding to each classifier of the k classifiers. In this case, efficiency of determining an ALF category is improved, and compression efficiency is further improved.

In addition, how to determine the target category based on the target range, the intermediate information, and the category subset is further described.

In a possible implementation, for each classifier in the classifier group, a subcategory corresponding to each classifier may be determined by using the foregoing formula, and then the target category is determined by using the subcategory corresponding to each classifier.

In some examples, assuming that the information configured for classification includes two of the target range, the intermediate information, or the category subset, then reference may be made to descriptions in the related technology for excluded information configured for classification, and details are not described herein again.

In general, the more specific information is included in the information configured for classification, the more accurate is a corresponding ALF classification.

Methods in the foregoing embodiments may be performed by default, that is, both an encoder and a decoder perform the methods in the embodiments of this disclosure by default. In addition, the information configured for classification and used by the video encoding and decoding method may alternatively be preset and stipulated. For example, which information of a target range, intermediate information, or a category subset is configured for classification is stipulated.

In a possible implementation, a method in this embodiment of this disclosure includes at least one of the following:
using the target category as a category of an adaptive loop filter corresponding to a first image, where the first image is a sub-image in image data;
using the target category as a category of an adaptive loop filter corresponding to a second image, where the image data is a sub-image of the second image;
using the target category as a category of an adaptive loop filter corresponding to a third image, where the third image and the image data are located in a same image, and an image size of the third image and that of the image data are the same.

In this embodiment, after the target category corresponding to the image data is determined, the target category may be used as the ALF category corresponding to the first image in the sub-image of the image data. Alternatively, the target category may be used as the ALF category corresponding to the second image including the image data. Besides, the target category may alternatively be used as the ALF category corresponding to the third image located in the same image as the image data.

At least one of the foregoing situations may be selected and set as required, and this is not limited herein.

In the technical solution of this embodiment, after the target category corresponding to the image data is calculated, the target category is used as the adaptive loop filter category corresponding to the first image, and the first image is the sub-image in the image data; and/or the target category is used as the adaptive loop filter category corresponding to the second image, and the image data is the sub-image of the second image; and/or the target category is used as the adaptive loop filter category corresponding to the third image, the third image and the image data are located in the same image, and the image size of the third image and that of the image data are the same. In this case, efficiency of determining the ALF category can be improved, and encoding and decoding efficiency is further improved.

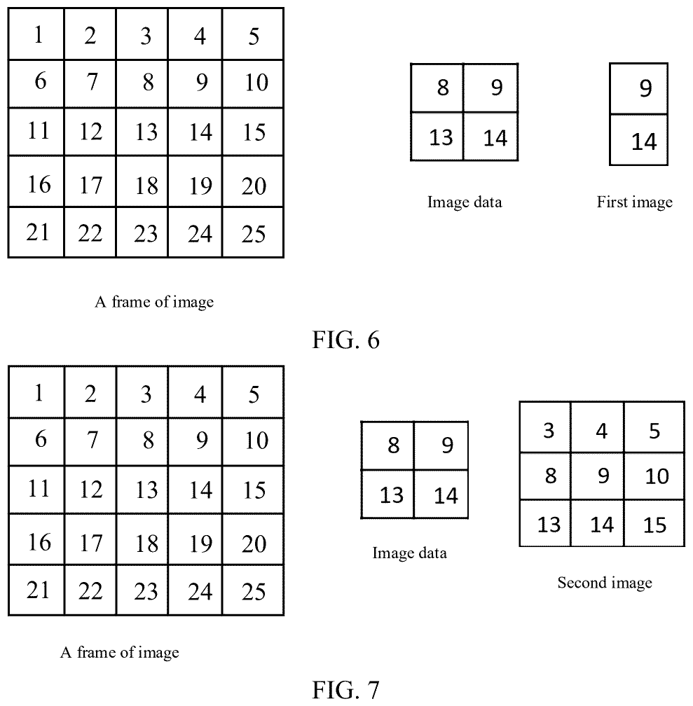

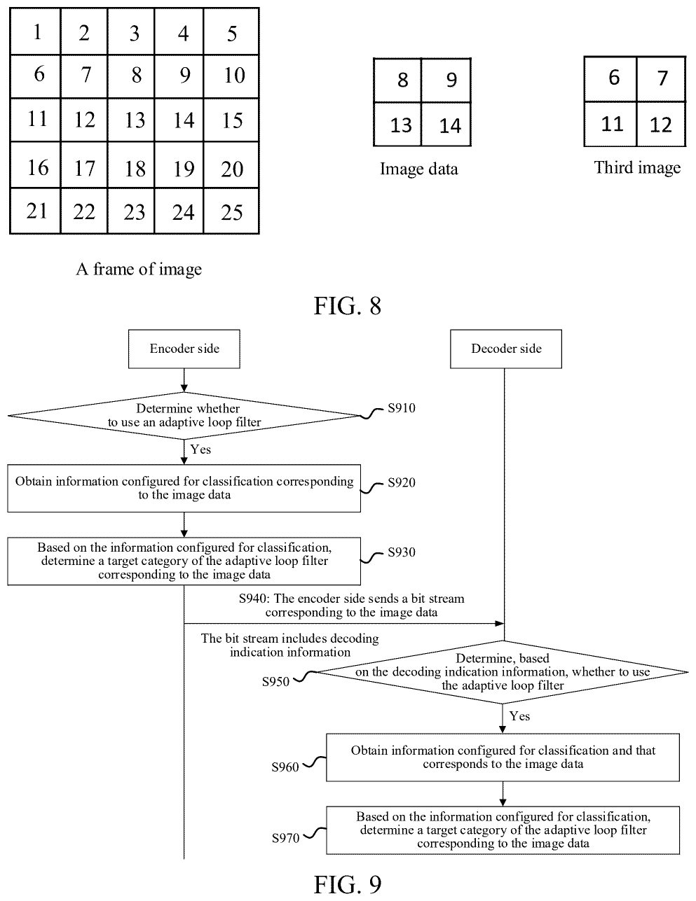

Refer to FIG. 6 to FIG. 8. FIG. 6 is a schematic diagram of comparison between image data and a first image according to an embodiment of this disclosure. FIG. 7 is a schematic diagram of comparison between image data and a second image according to an embodiment of this disclosure. FIG. 8 is a schematic diagram of comparison between image data and a third image according to an embodiment of this disclosure.

The ALF category corresponding to the first image shown in FIG. 6 may be the same as the target category. The ALF category corresponding to the second image shown in FIG. 7 may be the same as the target category. The ALF category corresponding to the third image shown in FIG. 8 may be the same as the target category.

In the technical solution of this embodiment, after the target category corresponding to the image data is determined, the target category is used as an ALF category of another image related to the image data. In this case, for the another image related to the image data, an ALF classification can be determined without performing a process of determining the target category, so that efficiency of determining the ALF classification is improved, and encoding and decoding efficiency is further improved.

In some example situations, an adaptive loop filter does not need to be used in some cases, or classification does not need to be performed by using the methods in the embodiments of this disclosure. If the classification is still performed based on the methods in the embodiments of this disclosure, flexibility of a process of determining a target category is not high, and both a decoder side and an encoder side perform some unnecessary processing.

Therefore, the following embodiments describe, based on any one of the foregoing embodiments, how to improve flexibility of a video encoding and decoding method.

FIG. 9 is a schematic flowchart of another video encoding and decoding method according to an embodiment of this disclosure. The method in FIG. 9 includes the following operations:

S910: An encoder side determines whether to use an adaptive loop filter.

How to determine whether to use an adaptive loop filter may be set as required, which is not limited herein. In this embodiment, if the adaptive loop filter is used, the process of determining the target category needs to be performed. Therefore, operation S920 may be performed.

S920: The encoder side obtains information configured for classification and that corresponds to the image data.

The information configured for classification in this embodiment may be information configured for performing ALF classification in the related technology, for example, a maximum range, or may be the information configured for classification mentioned in the embodiments of this disclosure, which is not limited herein.

In some examples, if the information configured for classification includes at least one of the target range, the intermediate information, or the category subset, then reference may be made to any of the foregoing embodiments for the information configured for classification, and details are not described herein again.

S930: Based on the information configured for classification, the encoder side determines a target category of the adaptive loop filter corresponding to the image data.

S940: The encoder side sends a bit stream corresponding to the image data to a decoder side, where the bit stream includes decoding indication information.

The bit stream may be obtained after the encoder side encodes the image data. The decoding indication information may indicate whether the decoder side performs a process of determining the target category, and this is not limited herein.

S950: The decoder side determines, based on the decoding indication information, whether to use the adaptive loop filter.

In this embodiment, if the decoder side determines, based on the decoding indication information, to use the adaptive loop filter, perform operation S960.

S960: The decoder side obtains information configured for classification corresponding to the image data.

In this embodiment, in general, the information configured for classification obtained by the decoder side is the same as the information obtained by the encoder side.

S970: Based on the information configured for classification, the decoder side determines a target category of the adaptive loop filter corresponding to the image data.

In the technical solution of this embodiment, the encoder side determines whether to use the adaptive loop filter, obtains the information configured for classification corresponding to the image data when the adaptive loop filter is determined to be used, and sends the bit stream including the decoding indication information to the decoder side. After receiving the bit stream, the decoder side may learn, based on the decoding indication information, whether to use the adaptive loop filter, perform the process of determining the target category (that is, the foregoing video encoding and decoding method) when the adaptive loop filter is determined to be used, and may select to start or end performing of the process of determining the target category as required. In this case, flexibility of ALF classification is improved.

In a possible implementation, the decoding indication information includes at least one of first indication information, second indication information, third indication information, fourth indication information, fifth indication information, or sixth indication information.

The first indication information may indicate whether to use the adaptive loop filter. In this embodiment, the encoder side may determine whether to use the adaptive loop filter, and further send the first indication information to the decoder side based on a determining result of whether to use the adaptive loop filter. The decoder side may also synchronously use the adaptive loop filter or not, and further determine whether to perform the process of determining the target category by the ALF.

In this embodiment, flexibility of whether to perform the process of determining the target category by the ALF can be improved by using the first indication information.

The second indication information may indicate information configured for classification in the process of determining the target category. In this embodiment, the encoder side may select as required one or more pieces of the information configured for classification, and then may notify the decoder side of the selected information by using the second indication information. In this case, the decoder side may also use the information configured for classification that is used by the encoder side when the encoder side performs the process of determining the target category.

The second indication information may implicitly notify the decoder side of the selected information configured for classification, for example, implicitly inform the decoder side of whether to use the target range, the intermediate information, or the category subset. The decoder side may calculate a specific target range, intermediate information, and a category subset based on the methods in the foregoing embodiments. In addition, the second indication information may explicitly notify the decoder side of the specific target range, the intermediate information, or the category subset used, for example, explicitly notify the decoder side that the target range used is 64 to 940, so that the decoder side can omit a calculation process of the information configured for classification, and directly use the explicit information configured for classification to perform the ALF classification.

In this embodiment, the information configured for classification used by the decoder side is explicitly notified, so that encoding and decoding efficiency can be improved.

The third indication information indicates performing the process of determining the target category. A target level includes at least one of an image sequence level, an image level, or a sub-image level. The image sequence level represents performing the process of determining the target category by using at least two frames of images as a unit; the image level represents performing the process of determining the target category by using one frame of image as a unit; a sub-image layer represents performing the process of determining the target category by using a sub-image in one frame of image as a unit; and the sub-image level includes at least one of a slice level, a tile level, or a block level.

In this embodiment, the encoder side may determine as required the target level at which the process of determining the target category needs to be performed, for example, perform the process of determining the target category at the image sequence level, perform the process of determining the target category at the image level, perform the process of determining the target category at the slice level, perform the process of determining the target category at the tile level, or perform the process of determining the target category at the block level. Then, the encoder side may notify the decoder side by using the third indication information, and the decoder side may also learn the target level at which the encoder side performs the process of determining the target category, so that the encoder side and the decoder side can perform the process of determining the target category at the same target level.

In this embodiment, a level corresponding to the specific information configured for classification indicated by the second indication information may be the same as or different from a level, indicated by the third indication information, at which the decoder side performs the process of determining the target category. For example, the third indication information may be configured to instruct the decoder side to perform the process of determining the target category at the sub-image level, the second indication information may indicate a specific target range corresponding to the sub-image level, or the second indication information may indicate a specific target range corresponding to the image level. This is not limited herein.

In this embodiment, the third indication information indicates a target level of performing the process of determining the target category, so that flexibility of a level applicable to the adaptive loop filtering classification can be improved.

The fourth indication information indicates a target sub-image of performing the process of determining the target category in a frame of image, where the target sub-image is at least one of sub-images obtained through division of the frame of image. In this embodiment, one frame of image can be divided into a plurality of sub-images.

In some situations, important content of a video is usually displayed at a middle position of a video image. Therefore, a partial sub-image of a frame of image may be selected to perform the process of determining the target category.

In this embodiment, the encoder side may determine, in each frame of image, a target sub-image on which adaptive loop filtering needs to be performed, and perform the process of determining the target category for the target sub-image. Then, the encoder side may notify the encoder side by using the fourth indication information, and the decoder side may also learn the target sub-image, so that the decoder side can perform the process of determining the target category for the target sub-image. In this embodiment, the target sub-image can reflect main content in the frame of image.

In this embodiment, the fourth indication information indicates the target sub-image of performing the process of determining the target category in the frame of image, and the partial sub-image of the frame of image can be selected to perform the process of determining the target category, so that video quality and encoding and decoding efficiency can both be improved.

The fifth indication information indicates a size of a target sub-image of performing the process of determining the target category in a frame of image.

In some cases, an excessively large size or an excessively small size may have a certain impact on a filtering effect, and further have a certain impact on video encoding and decoding efficiency and video quality. Therefore, the adaptive loop filtering may be performed by selecting sub-images of different sizes based on an actual situation.

In this embodiment, the encoder side may, as required, determine a target size of the sub-image on which the adaptive loop filtering needs to be performed, and then perform the process of determining the target category for the sub-image of the target size. Then, the encoder side may notify the encoder side by using the fifth indication information, and the decoder side may also learn the target size, so that the decoder side can perform the process of determining the target category for the sub-image of the target size. In an embodiment, the sub-image of the target size can reflect main content in the frame of image. In an embodiment, the size may include a shape, a dimension, and the like.

In this embodiment, the fifth indication information indicates the size of the sub-image of performing the process of determining the target category in the frame of image, and the size of the sub-image can be selected to perform the process of determining the target category, so that video quality and encoding and decoding efficiency can both be improved.

The sixth indication information indicates a quantity of images in the image sequence for performing the process of determining the target category.

In some cases, in a video, in general, a content difference of several consecutive image frames is small, while that of several another consecutive image frames is large. Therefore, at least two frames in the image sequence for performing the process of determining the target category may have a certain impact on video quality. Therefore, the quantity of images in the image sequence for performing the process of determining the target category may be selected as required.

In this embodiment, the encoder side may determine, as required, at least two frames of images for performing the process of determining the target category, form an image sequence by using the at least two frames of images, and then perform the process of determining the target category for the image sequence. Then, the encoder side notifies the decoder side by using the sixth indication information, so that the decoder side can perform the process of determining the target category for the image sequence by using the same image sequence. In an embodiment, the image sequence may include at least two frames of images with a small content difference.

For example, the encoder side uses a first frame of image, a second frame of image, and a third frame of image as a group of image sequences, and the encoder side may send the sixth indication information indicating that a quantity of images is 3. In this case, the decoder side may start calculation from the first frame of image in a bit stream to the third frame of image. Then, the encoder side uses a fourth frame of image and a fifth frame of image as a group of image sequences, and the encoder side may send the sixth indication information indicating that the quantity of images is 2. In this case, the decoder side may start calculation from the fourth frame of image in the bit stream to the fifth frame of image.

In this embodiment, the sixth indication information indicates the quantity of images in the image sequence for performing the process of determining the target category, so that video quality can be improved.

If the decoder side receives one of the second indication information, the third indication information, the fourth indication information, the fifth indication information, and the sixth indication information, then an adaptive loop filter is needed for video encoding and decoding.

For ease of understanding, the following embodiments respectively describe the target range, the intermediate range, and the classification subset with reference to a technical solution of decoding indication information.

First, a technical solution of combining the target range with the decoding indication information is described. In the following examples, the target range may also be referred to as a true dynamic range.

This embodiment proposes that a real dynamic range is be used during ALF classification. The real dynamic range means that a dynamic range of classified content does not need to be the same as a maximum range that can be represented by a signal bit width. For example, for a signal using a 10-bit width, a maximum range that can be represented is 0 to 1023, and a real dynamic range of a segment of content is a subset of the maximum range.

Embodiment 1.1: The real dynamic range is generated by analyzing content that needs to be classified. The content may be sourced from an image sequence, a frame of image, a slice, a tile, or a block.

Embodiment 1.1.1: The real dynamic range is generated based on content of an entire video sequence. By analyzing the entire image sequence, a minimum value and a maximum value of a signal value of the sequence are found, and are used as a real dynamic range of the image sequence when the ALF classification is performed.

Embodiment 1.1.2: The real dynamic range is generated based on content of a frame. By analyzing the content of the frame, a minimum value and a maximum value of a signal value of the image are found, and are used as a real dynamic range of the content of the frame when the ALF classification is performed.

Embodiment 1.1.3: The real dynamic range is generated based on content of a slice. By analyzing the content of the slice, a minimum value and a maximum value of a signal value of the slice are found, and are used as a real dynamic range of the content of the slice when the ALF classification is performed.

Embodiment 1.1.4: The real dynamic range is generated based on content of a tile. By analyzing the content of the tile, a minimum value and a maximum value of a signal value of the tile are found, and are used as a real dynamic range of the content of the tile when the ALF classification is performed.

Embodiment 1.1.5: The real dynamic range is generated based on content of a block. By analyzing the content of the block, a minimum value and a maximum value of a signal value of the block are found, and are used as a real dynamic range of the content of the block when the ALF classification is performed. A size of the block may be 256×256, 128×128, 64×64, 32×32, or the like.

Embodiment 1.2: A real dynamic range configured for the ALF classification is an interval predefined at both an encoder side and a decoder side, and the interval is a sub-interval of a maximum dynamic range that can be represented by a signal bit width.

Embodiment 1.2.1: A dynamic range specified by ITU-R BT.2020 may be used as the real dynamic range, that is, an effective dynamic range of content represented by using a 10-bit width is [64, 940].

Embodiment 1.3: Whether a real dynamic range is used during the ALF classification needs to be transmitted at an HLS (that is, a VPS, an SPS, a PPS, an APS, a Picture Header, a Slice Header) or block level (that is, 256×256, 128×128, 64×64, 32×32, and the like).

Embodiment 1.4: A real dynamic range used during the ALF classification is transmitted to the decoder side with an ALF filter bank. When the filter bank is selected to perform ALF filtering, a corresponding real dynamic range is configured for classification.

Embodiment 1.5: A real dynamic range used during the ALF classification needs to be transmitted at an HLS (that is, a VPS, an SPS, a PPS, an APS, a Picture Header, a Slice Header) or block level (that is, 256×256, 128×128, 64×64, 32×32, or the like).

Embodiment 1.6: When whether a real dynamic range is used during the ALF classification has a plurality of levels of switches, a switch of each level needs to be explicitly transmitted to the decoder side.

Embodiment 1.6.1: When whether a real dynamic range is used during the ALF classification may be determined at different sizes of block levels (for example, may be determined at block levels of four different sizes, to be specific, 256×256, 128×128, 64×64, and 32×32), an optimal block-level switch size needs to be transmitted to the decoder side.

Embodiment 1.6.2: When whether a real dynamic range is used during the ALF classification may be determined at both a non-block level (a sequence level, a frame level, a slice level, a tile level, or the like) and a block level (256×256, 128×128, 64×64, 32×32, or the like), a flag bit of whether the switch is a block-level switch (or a non-block-level switch) needs to be transmitted first, and if the flag bit is true, an optimal block-level switch size (or an optimal non-block-level switch level) is further transmitted. Otherwise, the switch is the non-block-level switch (or the block-level switch), and the optimal non-block-level switch level (or the optimal block-level switch size) is further transmitted.

Embodiment 1.7: When whether a real dynamic range is used during the ALF classification may be generated based on a plurality of levels of content, whether the content of each level is configured for generating the real dynamic range needs to be explicitly transmitted to the decoder side.

Embodiment 1.7.1: When a real dynamic range used during the ALF classification may be generated based on different sizes of block-level content (for example, may be generated based on block-level content of four different sizes, to be specific, 256×256, 128×128, 64×64, and 32×32), an optimal block-level size needs to be transmitted to the decoder side.

Embodiment 1.7.2: When a real dynamic range used during the ALF classification may be generated at both the non-block level (the sequence level, the frame level, the slice level, the tile level, or the like) and the block level (256×256, 128×128, 64×64, 32×32, or the like), a flag bit of whether block-level content is used for generation (or non-block-level content is used for generation) needs to be transmitted first, and if the flag bit is true, the optimal block-level size (or the optimal non-block-level level) is further transmitted. Otherwise, the non-block-level content is used for generation (or the block-level content is used for generation), and the optimal non-block-level level (or the optimal block-level size) is further transmitted.

Embodiment 1.8: When a plurality of real dynamic ranges that are simultaneously predefined at both the encoder side and the decoder side may be used during the ALF classification, an optimal real dynamic range needs to be transmitted to the decoder side.

Embodiment 1.8.1: When n predefined real dynamic ranges are used during the ALF classification, the dynamic ranges respectively are [l₀, h₀], [l₁, h₁] . . . , [lₙ₋₁, hₙ₋₁]. Intervals are different from each other, and at most one dynamic range is a maximum dynamic range that can be represented by a signal bit width, and remaining dynamic ranges are sub-ranges of the maximum dynamic range that can be represented by the signal bit width. The encoder side selects an optimal real dynamic range through comparison, and transmits the optimal real dynamic range to the decoder side.

Embodiment 1.9: When a real dynamic range is configured for the ALF classification, a final category of the real dynamic range is generated based on the following formula:

$$classIdx = \frac{( input - {range}_{min} ) * total\_number}{{range}_{max} - {range}_{min} + 1}$$

In the formula, input represents information configured for classification, rangeₘᵢₙ, rangeₘₐₓ respectively represent a minimum value and a maximum value of the real dynamic range, and total_number represents a quantity of all categories of a corresponding classifier.

Embodiment 1.9.1: A classifier of a real dynamic range is configured to classify single samples. The classifier classifies each sample, to generate a corresponding category. In this case, information of the single samples is used as an input of the classifier.

Embodiment 1.9.2: A classifier of a real dynamic range is configured to classify sub-blocks. The classifier classifies each N×N (such as 2×2, 4×4) sub-block, and all samples (pixels) in the sub-block use the same category. In this case, information of an M×M area (M≥N) including the N×N sub-block is used as an input of the classifier, and the real dynamic range needs to be modified into a real dynamic range corresponding to M×M.

Second, a technical solution of combining the intermediate information with the decoding indication information is described.

In this embodiment, during the ALF classification, intermediate information generated in another encoding and decoding process is used as an input of a classifier, to perform classification. The intermediate information generated in the encoding and decoding process refers to information other than information already used by a current ALF classifier.

Embodiment 2.1: A reconstructed component before being filtered by a deblocking filter is used as an input of a classifier for classification.

Embodiment 2.2: A reconstructed component filtered by a fixed filter and not filtered by the deblocking filter is used as an input of the classifier for the classification. In this method, first, the fixed filter needs to be configured to filter the reconstructed component before being filtered by the deblocking filter, and then a filtering output is configured for the classification.

Embodiment 2.3: A to-be-processed signal that is filtered by the deblocking filter is used as an input of the classifier for the classification. In this method, the current to-be-processed signal first needs to be filtered by the fixed filter, and then a filtering output is configured for the classification.

Embodiment 2.4: Whether the intermediate information generated in another encoding and decoding process is used during the ALF classification needs to be transmitted at an HLS (that is, a VPS, an SPS, a PPS, an APS, a Picture Header, a Slice Header) or block level (that is, 256×256, 128×128, 64×64, 32×32, and the like).

A classifier provided in this embodiment and that uses the intermediate information generated in another encoding and decoding process for classification may be applied to a single sample, or may be applied to a block level (for example, 2×2 or 4×4), and all samples within a block use a same category.

As provided in this embodiment, performing classification for the intermediate information generated in another encoding and decoding process is applicable to any process of determining a target category, and only corresponding intermediate information needs to be used as an input of the classifier.

In addition, a technical solution of combining the category subset with the decoding indication information is described.

This embodiment proposes that during the ALF classification, a combined classifier combining a plurality of single classifiers is configured for the classification. Classifiers configured for combination may be any classifier, for example, a gradient-based classifier, a 2×2 block-based classifier, and a residual-component-based classifier used in 2.1.1 and 2.1.2.

Assuming that k single classifiers (which respectively are classifier₀, classifier₁, . . . , classifierₖ₋₁) are combined into one classifier, and quantities of categories corresponding to the single classifiers respectively are n₀, n₁, . . . , nₖ₋₁. A final category index of the combined classifier is generated based on the following formula:

$$classIdx = ( {n}_{1} * {n}_{2} * … * {n}_{k - 1} ) * {classIdx}_{0} + ( {n}_{2} * … * {n}_{k - 1} ) * {classIdx}_{1} + … + {classIdx}_{k - 1}$$

In the formula, classIdx₀, classIdx₁, . . . , classIdxₖ₋₁ respectively are category indexes corresponding to the single classifiers.

Embodiment 3.1: A classifier obtained by combining the gradient-based classifier and a sample-based classifier is configured for the ALF classification. In this embodiment, two single classifiers are included, where a quantity of categories of each single classifiers is n₀=25, n₁=25, and the final category index of the combined classifier is:

$$classIdx = 25 * {classIdx}_{0} + {classIdx}_{1}$$

Whether the combined classifier is used during the ALF classification needs to be transmitted at an HLS (that is, a VPS, an SPS, a PPS, an APS, a Picture Header, a Slice Header) or block level (that is, 256×256, 128×128, 64×64, 32×32, and the like).

The combined classifier provided in this embodiment mat be applied to a single sample, or may be applied to the block level (for example, 2×2 or 4×4), and all samples within a block use a same category.

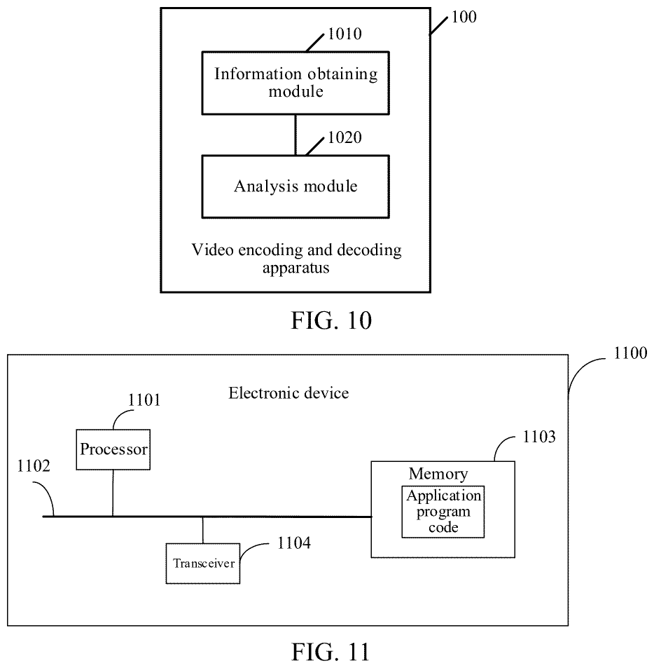

FIG. 10 is a schematic diagram of a structure of a video encoding and decoding apparatus 100 according to an embodiment of this disclosure. The video encoding and decoding apparatus 100 in FIG. 10 includes an information obtaining module 1010 and a classification module 1020.

The information obtaining module 1010 is configured to obtain information configured for classification that is of image data, where the information configured for classification includes at least one of a target range, intermediate information, or a category subset.

The classification module 1020 is configured to determine, for the image data, a target category corresponding to the information configured for classification, where the target category indicates a category of an adaptive loop filter for encoding and decoding of the image data.

The target range includes at least one of a first dynamic range or a second dynamic range, where the first dynamic range is a value range determined based on pixel information of the image data, the second dynamic range is a preset range determined from one or more preset ranges, and at least one of the preset ranges is less than a maximum range that can be represented by a signal bit width of the image data.

The intermediate information includes information generated in the encoding and decoding of the image data.

The category subset includes at least two subcategories, and the at least two subcategories are categories of the image data respectively determined based on classifiers in a classifier group.

In a possible implementation, a range minimum value of the first dynamic range is determined based on a minimum signal value of the image data, and a range maximum value of first dynamic range is determined based on a maximum signal value of image data.

In a possible implementation, the image data includes at least one of an original uncompressed signal, a reconstructed signal, a residual signal, or a predicted signal; and the minimum signal value and the maximum signal value are determined based on at least one of the original uncompressed signal, the reconstructed signal, the residual signal, or the predicted signal.

In a possible implementation, the second dynamic range is selected from N preset ranges. In the N preset ranges, M preset ranges are the maximum range, and N-M preset ranges are less than the maximum range.

M is a natural number less than 2, and N≥2.

In a possible implementation, the classification module 1020 is further configured to perform at least one of the following:
using the target category as a category of an adaptive loop filter corresponding to a first image, where the first image is a sub-image in image data;
using the target category as a category of an adaptive loop filter corresponding to a second image, where the image data is a sub-image of the second image;
using the target category as a category of an adaptive loop filter corresponding to a third image, where the third image and the image data are located in a same image, and an image size of the third image and that of the image data are the same.

In a possible implementation, the intermediate information includes at least one of the following:
a reconstructed signal before being filtered by a deblocking filter, where the reconstructed signal includes a reconstructed signal after being filtered by a fixed filter or a reconstructed signal not being filtered by a fixed filter; and
a to-be-processed signal after being filtered by a fixed filter, where the to-be-processed signal includes a luminance signal.

In a possible implementation, the information configured for classification includes a category subset; and the target category is determined from L preset categories based on at least two subcategories, where L is a product of a quantity of categories respectively corresponding to each classifier in a classifier group.

In a possible implementation, a subcategory is represented through a category index, and a subcategory is a category in a plurality of categories corresponding to a classifier.

The determining, based on the information configured for classification, a target category of an adaptive loop filter corresponding to the image data includes:

based on the category index of each subcategory in a category subset, determining a category index classIdx of the target category by using the following expression:

$$classIdx = ( {n}_{1} * {n}_{2} * … * {n}_{k - 1} ) * {classIdx}_{0} + ( {n}_{2} * … * {n}_{k - 1} ) * {classIdx}_{1} + … + {classIdx}_{k - 1}$$

In the expression, k represents a quantity of classifiers included in the classifier group, nₖ₋₁ represents a quantity of categories corresponding to a k^{th} classifier, and classIdxₖ₋₁ represents an index of a subcategory corresponding to the k^{th} classifier in the category subset.

In a possible implementation, the video encoding and decoding apparatus 100 is applied to an encoder side, and the video encoding and decoding apparatus 100 is further configured to determine whether an adaptive loop filter is used.

If the adaptive loop filter is determined to be used, perform a process of determining a target category and send a bit stream corresponding to image data to a decoder side, where the bit stream includes decoding indication information, and the decoding indication information includes at least one of first indication information, second indication information, third indication information, fourth indication information, fifth indication information, or sixth indication information.

The first indication information indicates whether to use the adaptive loop filter;
the second indication information indicates information configured for classification;
the third indication information indicates a target level of the process of determining the target category, where the target level includes at least one of a sequence level, a frame level, a slice level, a tile level, or a block level;
the fourth indication information indicates a target sub-image for performing the video encoding and decoding method in a frame of image, where the target sub-image is at least one of sub-images obtained through division of the frame of image;
the fifth indication information indicates a size of a sub-image for performing the video encoding and decoding method in a frame of image; and
the sixth indication information indicates a quantity of images in an image sequence for performing the video encoding and decoding method.

In a possible implementation, the video encoding and decoding apparatus 100 is applied to a decoder side, and the video encoding and decoding apparatus 100 is further configured to receive a bit stream, where the bit stream includes decoding indication information.

Based on the decoding indication information, if an adaptive loop filter is determined to be used, perform the foregoing video encoding and decoding method.

The decoding indication information includes at least one of first indication information, second indication information, third indication information, fourth indication information, fifth indication information, or sixth indication information.

The first indication information indicates whether to use the adaptive loop filter;
the second indication information indicates information configured for classification;
the third indication information indicates a target level of determining the target category, where the target level includes at least one of a sequence level, a frame level, a slice level, a tile level, or a block level;
the fourth indication information indicates a target sub-image for performing the video encoding and decoding method in a frame of image, where the target sub-image is at least one of sub-images obtained through division of the frame of image;
the fifth indication information indicates a size of a sub-image for performing the video encoding and decoding method in a frame of image; and
the sixth indication information indicates a quantity of images in an image sequence for performing the video encoding and decoding method.

The video encoding and decoding apparatus 100 in this embodiment may perform operations of adaptive loop filtering classification described in the foregoing embodiments of this disclosure. An implementation principle thereof is similar and is not described herein again.

For beneficial effects of the video encoding and decoding apparatus 100 during video encoding and decoding, refer to foregoing descriptions for the video encoding and decoding method. The same applies to the following descriptions of effects of an electronic device, a computer-readable storage medium, and a computer program product part.

The embodiments of this disclosure provide an electronic device, including a memory, a processor, and a computer program that is stored in the memory. The processor performs the computer program to implement operations of the method according to any of the foregoing embodiments.

Some aspects of the disclosure provide an electronic device. As shown in FIG. 11, an electronic device 1100 includes a processor 1101 and a memory 1103. The processor 1101 and the memory 1103 are interconnected, for example, through a bus 1102. In an embodiment, the electronic device 1100 may further include a transceiver 1104. The transceiver 1104 may be configured to perform data interaction between the electronic device and another electronic device, such as data sending and/or data receiving. In an actual application, a quantity of the transceiver 1104 is not limited to one, and a structure of the electronic device 1100 does not constitute a limitation to this embodiment of this disclosure.

The processor 1101 may be a central processing unit (CPU), a general purpose processor, a digital signal processor (DSP), an application specific integrated circuit (ASIC), a field programmable gate array (FPGA), or another programmable logic device, a transistor logic device, a hardware component, or any combination thereof. The processor 1101 may implement or execute various example logical blocks, modules, and circuits described with reference to content disclosed in this disclosure. Alternatively, the processor 1101 may be a combination of processors that implements a computing function, for example, a combination of one or more microprocessors, or a combination of the DSP and a microprocessor.

The bus 1102 may include a path for transmitting information between the foregoing components. The bus 1102 may be a peripheral component interconnect (PCI) bus, an extended industry standard architecture (EISA) bus, or the like. The bus 1102 may be classified into an address bus, a data bus, a control bus, and the like. For ease of representation, only one thick line is configured to represent the bus in FIG. 11, but this does not mean that there is only one bus or only one type of bus.

The memory 1103 may be a read only memory (ROM) or another type of static storage device that can store static information and instructions, a random access memory (RAM) or another type of dynamic storage device that can store information and instructions, or may be an electrically erasable programmable read only memory (EEPROM), a compact disc read only memory (CD-ROM) or another optical disk storage, an optical disk storage (including a compact disc, a laser disk, an optical disc, a digital versatile disc, a blu-ray disc, and the like), a magnetic disk storage medium, another magnetic storage device, or any other medium that can be configured to carry or store a computer program and can be read by a computer. This is not limited herein.

The memory 1103 is configured to store a computer program for performing the embodiments of this disclosure, and is controlled and executed by the processor 1101. The processor 1101 is configured to execute the computer program stored in the memory 1103, to implement the operations described in the foregoing method embodiments.

The embodiments of this disclosure provide a computer readable storage medium, where the computer-readable storage medium stores a computer program, and operations of corresponding content of the foregoing method embodiments may be implemented when the computer program is executed by a processor.

The embodiments of this disclosure further provide a computer program product, including a computer program, and the computer program, when executed by a processor, may implement the operations and corresponding content of the foregoing method embodiments.

Although each operation is indicated by an arrow in flowcharts of the embodiments of this disclosure, an implementation sequence of the operations is not limited to a sequence indicated by the arrow. Unless explicitly described in this specification, in some implementation scenarios of the embodiments of this disclosure, implementation operations in the flowcharts may be performed in another sequence as required. In addition, some or all operations in each flowchart may include a plurality of sub-operations or a plurality of stages based on an actual implementation scenario. Some or all of these sub-operations or stages may be executed at a same moment, or each of these sub-operations or stages may be separately executed at different moments. In a scenario with different execution moments, an execution sequence of these sub-operations or stages may be flexibly set as required. This is not limited in the embodiments of this disclosure.

In the claims, specification, and accompanying drawings of this disclosure, terms “first”, “second”, and the like are intended to distinguish between different objects but do not indicate a particular order. In addition, terms “include”, “have”, and any variants thereof are intended to indicate non-exclusive inclusion. For example, a process, method, system, product, or device that includes a series of operations or units is not limited to the listed operations or units; and instead, further includes an operation or a unit that is not listed, or further includes another operation or unit that is intrinsic to the process, method, product, or device in some examples. Embodiment mentioned in the specification means that particular features, structures, or characteristics described with reference to the embodiment may be included in at least one embodiment of this disclosure. A person skilled in the art should understand that the embodiments described in the specification may be combined with other embodiments. The term “and/or” used in the specification and the appended claims of this disclosure refers to any and all possible combinations of one or more of related listed items, and includes these combinations.

A person of ordinary skill in the art may realize that, in combination with the embodiments herein, units and algorithm operations of each example described may be implemented by electronic hardware, computer software, or a combination thereof. To clearly describe the interchangeability between the hardware and the software, the foregoing has generally described compositions and operations of each example based on functions. A person skilled in the art may use different methods to implement the described functions for each particular disclosure, but it should not be considered that the implementation goes outside the scope of this disclosure.

What is disclosed above is merely some embodiments of this disclosure, and is not intended to limit the protection scope of this disclosure. Therefore, equivalent variations made in accordance with the claims of this disclosure shall fall within the scope of this disclosure.

In the embodiments of this disclosure, the term “module” or “unit” refers to a computer program or a part of a computer program having a predetermined function, and works together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

What is claimed is:

1. A method of video processing, the method comprising:
obtaining classification information of image data, the classification information comprising at least one of a target range, intermediate information, or a category subset; and
determining, for the image data, a target category according to the classification information, the target category indicating a category of an adaptive loop filter to be used during processing of the image data, wherein:
the target range comprises at least one of a first dynamic range or a second dynamic range, the first dynamic range being a value range determined based on pixel information of the image data, the second dynamic range being a preset range selected from one or more preset ranges, and at least one of the one or more preset ranges having a range width that is less than a maximum range width for a signal bit width of the image data;
the intermediate information is generated during the processing of the image data; and
the category subset comprises at least two subcategories that are respectively determined based on respective classifiers in a classifier group.

2. The method according to claim 1, wherein the image data is of one of a sequence-level, a frame-level, a slice-level, a tile-level, or a block-level.

3. The method according to claim 1, wherein a range minimum value of the first dynamic range is determined based on a minimum signal value of the image data, and a range maximum value of the first dynamic range is determined based on a maximum signal value of the image data.

4. The method according to claim 3, wherein the image data comprises at least one of an original uncompressed signal, a reconstructed signal, a residual signal, or a predicted signal.

5. The method according to claim 1, wherein:
the second dynamic range is selected from N preset ranges;
the N preset ranges include M preset ranges having the maximum range width, and N-M preset ranges with range widths less than the maximum range width; and
M is a natural number less than 2, and N is an integer that is equal to or greater than 2.

6. The method according to claim 1, further comprising at least one of:
using the target category as a category of an adaptive loop filter to be applied on a first image that is a sub-image in the image data;
using the target category as a category of an adaptive loop filter to be applied on a second image, the image data being a sub-image of the second image; or
using the target category as a category of an adaptive loop filter to be applied on a third image, the third image and the image data being located in a same image, and having a same size.

7. The method according to claim 1, wherein the intermediate information comprises at least one of:
a reconstructed signal before being filtered by a deblocking filter, the reconstructed signal being filtered by a fixed filter or not being filtered by the fixed filter; or
a to-be-processed signal after being filtered by the fixed filter, the to-be-processed signal comprising a luma signal.

8. The method according to claim 1, wherein the classification information comprises the category subset, and the target category is determined, from L preset categories, based on the at least two subcategories, L being a product of quantities of categories respectively associated with the respective classifiers in the classifier group.

9. The method according to claim 8, wherein:
the at least two subcategories are represented through respective category indices, and a subcategory in the at least two subcategories that is determined by a classifier in the classifier group is one category in a range of categories of the classifier; and
the determining the target category comprises:
determining a category index classIdx of the target category based on the respective category indices of the at least two subcategories by using:
$$classIdx = ( {n}_{1} * {n}_{2} * … * {n}_{k - 1} ) * {classIdx}_{0} + ( {n}_{2} * … * {n}_{k - 1} ) * {classIdx}_{1} + … + {classIdx}_{k - 1}$$
k representing a quantity of the respective classifiers in the classifier group, nₖ₋₁ representing a quantity of categories associated with a k^{th} classifier, and classIdxₖ₋₁ representing an index of a subcategory determined based on the k^{th} classifier in the category subset.

10. The method according to claim 1, wherein the video processing encodes a video into a bitstream, and the method comprises:
determining whether to use the adaptive loop filter;
when the adaptive loop filter is determined to be used, performing the video processing to generate the bitstream based on the adaptive loop filter, the bitstream comprising decoding indication information, and the decoding indication information comprising at least one of first indication information, second indication information, third indication information, fourth indication information, fifth indication information, or sixth indication information;
the first indication information indicating whether to use the adaptive loop filter;
the second indication information indicating the classification information;
the third indication information indicating a target level for performing the video processing, and the target level comprising at least one of a sequence level, a frame level, a slice level, a tile level, or a block level;
the fourth indication information indicating a target sub-image for performing the video processing in an image frame, and the target sub-image being at least one of sub-images of the image frame, the sub-images being obtained by a division of the image frame;
the fifth indication information indicating a size of a sub-image for performing the video processing in an image frame; and
the sixth indication information indicating a quantity of images in an image sequence for performing the video processing.

11. The method according to claim 1, wherein the video processing decodes a bitstream, and the method comprises:
receiving the bitstream that comprises decoding indication information;
performing the video processing based on the decoding indication information, when the adaptive loop filter is determined to be used;
the decoding indication information comprising at least one of first indication information, second indication information, third indication information, fourth indication information, fifth indication information, or sixth indication information;
the first indication information indicating whether to use the adaptive loop filter;
the second indication information indicating the classification information;
the third indication information indicating a target level for performing the video processing, and the target level comprising at least one of a sequence level, a frame level, a slice level, a tile level, or a block level;
the fourth indication information indicating a target sub-image for performing the video processing in an image frame, and the target sub-image being at least one of sub-images of the image frame, the sub-images being obtained by a division of the image frame;
the fifth indication information indicating a size of a sub-image for performing the video processing in an image frame; and
the sixth indication information indicating a quantity of images in an image sequence for performing the video processing.

12. An apparatus of video processing, comprising processing circuitry configured to:
obtain classification information of image data, the classification information comprising at least one of a target range, intermediate information, or a category subset; and
determine, for the image data, a target category according to the classification information, the target category indicating a category of an adaptive loop filter to be used during processing of the image data, wherein:
the target range comprises at least one of a first dynamic range or a second dynamic range, the first dynamic range being a value range determined based on pixel information of the image data, the second dynamic range being a preset range selected from one or more preset ranges, and at least one of the one or more preset ranges having a range width that is less than a maximum range width for a signal bit width of the image data;
the intermediate information is generated during the processing of the image data; and
the category subset comprises at least two subcategories that are respectively determined based on respective classifiers in a classifier group.

13. The apparatus according to claim 12, wherein the image data is of one of a sequence-level, a frame-level, a slice-level, a tile-level, or a block-level.

14. The apparatus according to claim 12, wherein a range minimum value of the first dynamic range is determined based on a minimum signal value of the image data, and a range maximum value of the first dynamic range is determined based on a maximum signal value of the image data.

15. The apparatus according to claim 14, wherein the image data comprises at least one of an original uncompressed signal, a reconstructed signal, a residual signal, or a predicted signal.

16. The apparatus according to claim 12, wherein:
the second dynamic range is selected from N preset ranges;
the N preset ranges include M preset ranges having the maximum range width, and N-M preset ranges with range widths less than the maximum range width; and
M is a natural number less than 2, and N is an integer that is equal to or greater than 2.

17. The apparatus according to claim 12, wherein the processing circuitry is configured to perform at least one of:
using the target category as a category of an adaptive loop filter to be applied on a first image that is a sub-image in the image data;
using the target category as a category of an adaptive loop filter to be applied on a second image, the image data being a sub-image of the second image; or
using the target category as a category of an adaptive loop filter to be applied on a third image, the third image and the image data being located in a same image, and having a same size.

18. The apparatus according to claim 12, wherein the intermediate information comprises at least one of:
a reconstructed signal before being filtered by a deblocking filter, the reconstructed signal being filtered by a fixed filter or not being filtered by the fixed filter; or
a to-be-processed signal after being filtered by the fixed filter, the to-be-processed signal comprising a luma signal.

19. The apparatus according to claim 12, wherein the classification information comprises the category subset, and the target category is determined, from L preset categories, based on the at least two subcategories, L being a product of quantities of categories respectively associated with the respective classifiers in the classifier group.

20. A non-transitory computer-readable storage medium storing a bitstream that is processed by a video processing method, the video processing method comprising:
obtaining classification information of image data, the classification information comprising at least one of a target range, intermediate information, or a category subset; and
determining, for the image data, a target category according to the classification information, the target category indicating a category of an adaptive loop filter to be used during processing of the image data, wherein:
the target range comprises at least one of a first dynamic range or a second dynamic range, the first dynamic range being a value range determined based on pixel information of the image data, the second dynamic range being a preset range selected from one or more preset ranges, and at least one of the one or more preset ranges having a range width that is less than a maximum range width for a signal bit width of the image data;
the intermediate information is generated during the processing of the image data; and
the category subset comprises at least two subcategories that are respectively determined based on respective classifiers in a classifier group.
